(19) United States
(12) Patent Application Publication
(10) Pub. No.: US 2017/0102816 A1
(43) Pub. Date: Apr. 13, 2017

(54) TOUCH SUBSTRATE AND TOUCH DEVICE

(71) Applicant: InnoLux Corporation, Jhu-Nan (TW)

(72) Inventors: Huei-Ying CHEN, Jhu-Nan (TW); Jian-Cheng CHEN, Jhu-Nan (TW); Shun-Fu CHIU, Jhu-Nan (TW); Shih-Che CHEN, Jhu-Nan (TW); Chung-Chun CHENG, Jhu-Nan (TW)

(21) Appl. No.: 15/288,284

(22) Filed: Oct. 7, 2016

(30) Foreign Application Priority Data
Oct. 9, 2015 (CN) 201510647795.X

(51) Int. Cl. G06F 3/041

(52) U.S. Cl. CPC G06F 3/0416; G06F 3/0412; G06F 2203/04103; G02F 1/13338

(57) ABSTRACT

A touch substrate and a touch device are disclosed. The touch substrate includes a substrate and a touch electrode structure, which has a first transparent conductive layer and a second transparent conductive layer. The first transparent conductive layer is disposed on the substrate and the second transparent conductive layer is disposed on the first transparent conductive layer. The first transparent conductive layer has a first side surface located at a first side of the first transparent conductive layer, and the second transparent conductive layer has a second side surface located above the first side. The first side surface has a first slope, and the second side surface has a second slope. The absolute value of the first slope is greater than that of the second slope. The light reflection amount of the touch sensing structure is reduced to improve the visibility of the touch substrate and touch device.

### CROSS REFERENCE TO RELATED APPLICATIONS

This Non-provisional application claims priority under 35 U.S.C. §119(a) on Patent Application No(s). 201510647795.X filed in People's Republic of China on Oct. 9, 2015, the entire contents of which are hereby incorporated by reference.

### BACKGROUND

Technical Field

The present disclosure relates to a touch substrate and a touch device, and in particular, to a touch substrate and a touch device that have better visibility.

Related Art

With the progress of technologies, various information devices, such as mobile phones, tablet computers, UMPC, and GPS, have been invented and introduced into our lives. Except the conventional input tools such as the keyboard or mouse, the intuitional touch input technology has been developed and becomes a popular operation method. Since the touch device has a humanized and intuitional input operation interface, the users of any ages can simply and directly use the finger or stylus to click or operation the information device.

Recently, a TOD (touch on display) technology, which is to directly install the touch sensors on the color filter substrate of the display panel (e.g. an LCD panel), to attach a polarizing component plate and to optionally cover a protective glass, is discussed. In the TOD, the touch sensors are electrode structures composed of multiple trace areas and multiple touch sensing areas, which are alternately arranged. The touch sensing area includes a driving electrode and a sensing electrode, and the trace area includes a plurality of traces for connecting to the touch control circuit. However, the electrode patterns of the touch sensing areas and trace areas will reflect light in a specific angle (or under the bright light) and show bright and dark lines, which make the touch device have poor visibility. The poor visibility means that the electrode patterns can be easily seen.

Therefore, it is desired to provide a touch substrate and a touch device that can reduce the light reflection amount of the touch sensing structure so as to improve the visibility thereof.

### SUMMARY

In view of the foregoing, the present disclosure is to provide a touch substrate and a touch device that can reduce the light reflection amount so as to improve the visibility thereof.

To achieve the above, the present disclosure discloses a touch substrate including a substrate and a touch electrode structure. The touch electrode structure has a first transparent conductive layer disposed on the substrate and a second transparent conductive layer disposed on the first transparent conductive layer. The first transparent conductive layer has a first side surface located at a first side of the first transparent conductive layer. The second transparent conductive layer has a second side surface located above the first side. The first side surface has a first slope, while the second side surface has a second slope. The absolute value of the first slope is greater than that of the second slope.

To achieve the above, the present disclosure also discloses a touch device including a first substrate, a second substrate disposed opposite to the first substrate, and a touch electrode structure having a first transparent conductive layer and a second transparent conductive layer. The first transparent conductive layer is disposed on the first substrate and the second transparent conductive layer is disposed on the first transparent conductive layer. The first transparent conductive layer has a first side surface located at a first side of the first transparent conductive layer. The second transparent conductive layer has a second side surface located above the first side. The first side surface has a first slope, while the second side surface has a second slope. The absolute value of the first slope is greater than that of the second slope.

In one embodiment, the material of each of the first and second transparent conductive layers comprises amorphous or crystalline material.

In one embodiment, the material of the first transparent conductive layer comprises IZO (indium-zinc oxide) or ITO (indium-tin oxide), and the second transparent conductive layer is made of ITO (indium-tin oxide) or Ge:ITO (germanium:indium-tin oxide).

In one embodiment, an etching rate of the first transparent conductive layer is greater than that of the second transparent conductive layer.

In one embodiment, the first transparent conductive layer has a first thickness, and the second transparent conductive layer has a second thickness. The ratio of the first thickness to the second thickness is between 0.1 and 10.

In one embodiment, the touch electrode structure has a plurality touch electrode patterns, which are arranged along a direction, and each of the touch electrode patterns comprises a trace area and a driving sensing area.

In one embodiment, the trace area comprises a trace, the driving sensing area contains a touch electrode, and the trace connects to the touch electrode and a control circuit board.

In one embodiment, the trace area comprises a trace, the driving sensing area contains a touch electrode, and the trace or the touch electrode has the first transparent conductive layer and the second transparent conductive layer.

In one embodiment, a ratio of a refraction index of the first transparent conductive layer to that of the second transparent conductive layer is between 0.9 and 1.1.

In one embodiment, the first side surface and a bottom surface of the first transparent conductive layer or the second side surface and a bottom surface of the second transparent conductive layer are formed with an obtuse angle.

As mentioned above, the touch electrode structure of the touch substrate and touch device of the disclosure has a second transparent conductive layer stacked on a first transparent conductive layer, and the absolute value of a slope of the first side surface of the first transparent conductive layer is greater than that of the second side surface of the second transparent conductive layer. Accordingly, the length of the traces of the touch electrode structure or the slant surface of the touch electrode is shorter than the conventional design, thereby decreasing the light reflection amount of the touch sensing structure so as to improve the visibility of the touch substrate and touch device.

### BRIEF DESCRIPTION OF THE DRAWINGS

The embodiments will become more fully understood from the detailed description and accompanying drawings, which are given for illustration only, and thus are not limitative of the present disclosure, and wherein:

FIG. 1 is a schematic diagram showing the relationship between the thickness, the transmittance, reflectiveness and absorption of a transparent conductive film;

FIG. 2A is a schematic diagram showing a touch device according to an embodiment of the present disclosure;

FIG. 2B is a top view of a touch electrode structure of the touch device of FIG. 2A;

FIG. 2C is an enlarged view showing an area of the touch electrode structure of FIG. 2B;

FIG. 2D is a side view showing a part of the touch electrode structure of FIG. 2B;

FIG. 3A to FIG. 3D are partial side views of the touch electrode structure of different aspects; and

FIG. 4 is a schematic diagram showing another touch device of the present disclosure.

### DETAILED DESCRIPTION

The embodiments of the disclosure will be apparent from the following detailed description, which proceeds with reference to the accompanying drawings, wherein the same references relate to the same elements.

In general, the transparent conductive oxide thin film (TCO) is used in manufacturing the touch sensing electrode and trace. The TCO has a transmittance up to 86% and a good electronic conductive property, which is a proper transmitting medium for electronic signals. In manufacturing processes, the thickness of the transparent conductive film is determined by two factors, the resistance and the visibility. In more detailed, the lower the required resistance is, the thicker the film is. Besides, the goal of visibility is to make the electrode patterns become invisible.

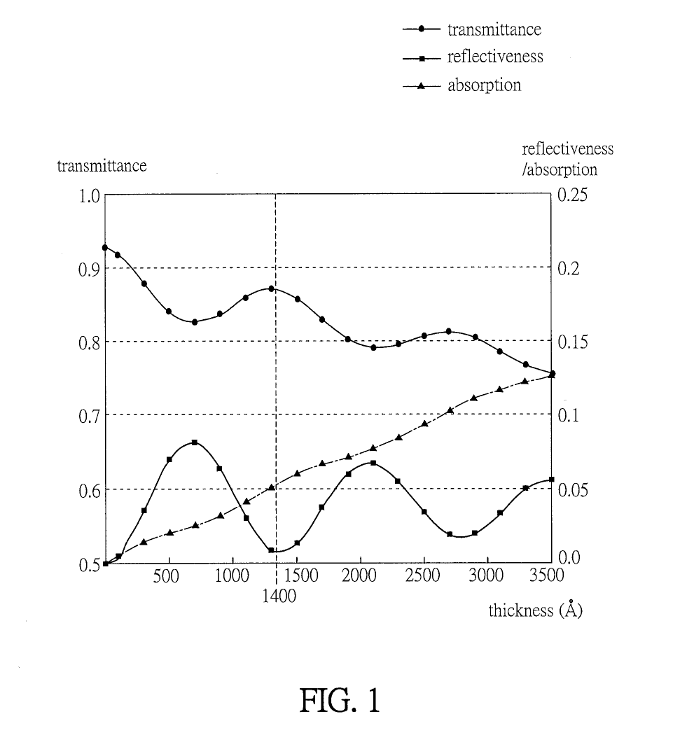

FIG. 1 is a schematic diagram showing the relationship between the thickness, the transmittance, reflectiveness and absorption of a transparent conductive film. In this case, the material of the transparent conductive film comprises ITO (indium-tin oxide).

As shown in FIG. 1, with considering the different transmittances of the transparent conductive film caused by light interference and the required resistance of the touch control IC, the ITO transparent conductive film preferably has a thickness of 1400 Å. Accordingly, the transparent conductive film has a better transmittance (T %) and a resistance smaller than 40Ω, which match the requirements of the touch sensing structure.

In addition, when the electrode patterns of the touch sensing structure is in a specific angle (or bright light), the slant surfaces of the electrode patterns may reflect the light to show the bright and dark lines. Besides, if the length of the slant surface of the electrode patterns is longer, the amount of the reflected light is larger, which makes the visibility of the electrode patterns worse. Accordingly, when manufacturing the single-layer touch sensing structure based on the TOD technology, the length of the slant surface of the electrode patterns should be reduced as many as possible, thereby decreasing the amount of the reflected light and improving the visibility.

The touch substrate and touch device according an embodiment of the present disclosure will be described hereinafter. Compared with the conventional arts, the touch electrode structure of the following embodiment has a shorter slant surface, so that the bright and dark lines caused by the reflected light can be reduced and the visibility thereof can be improved.

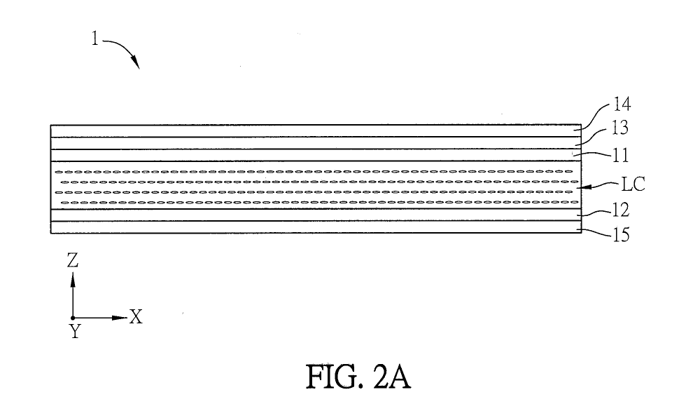

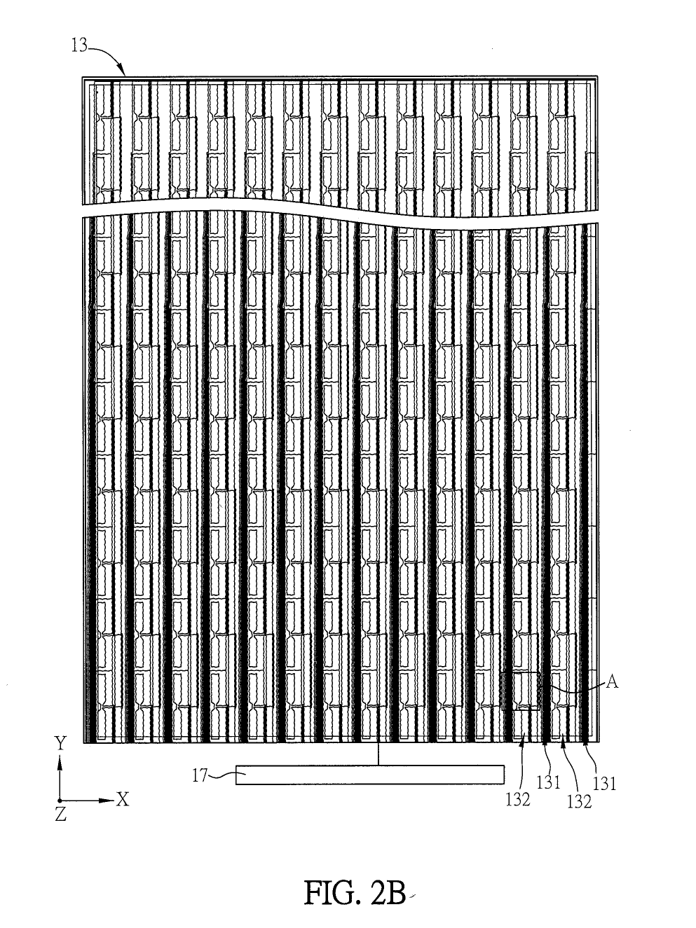

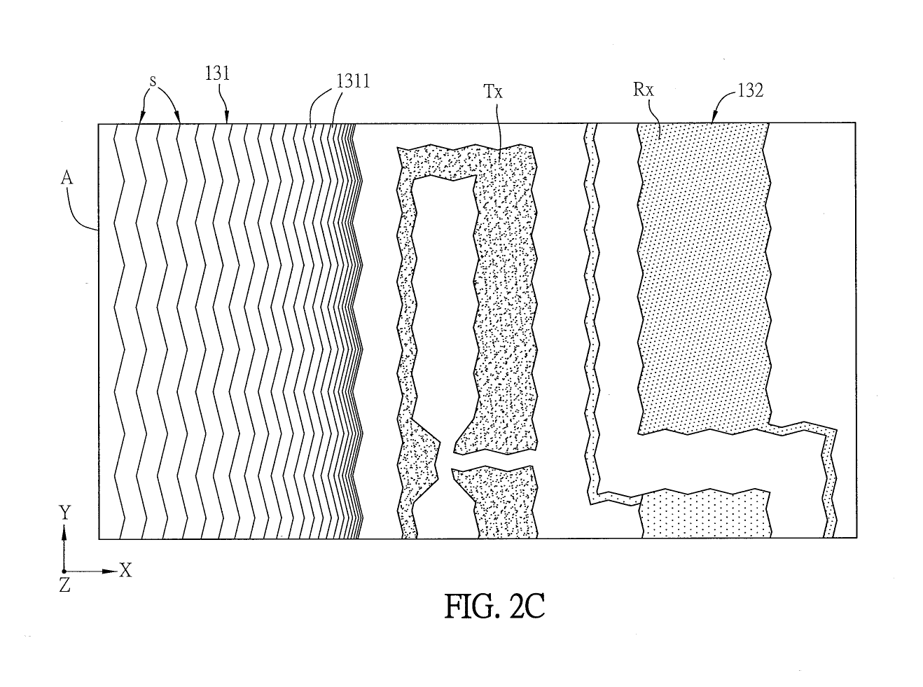

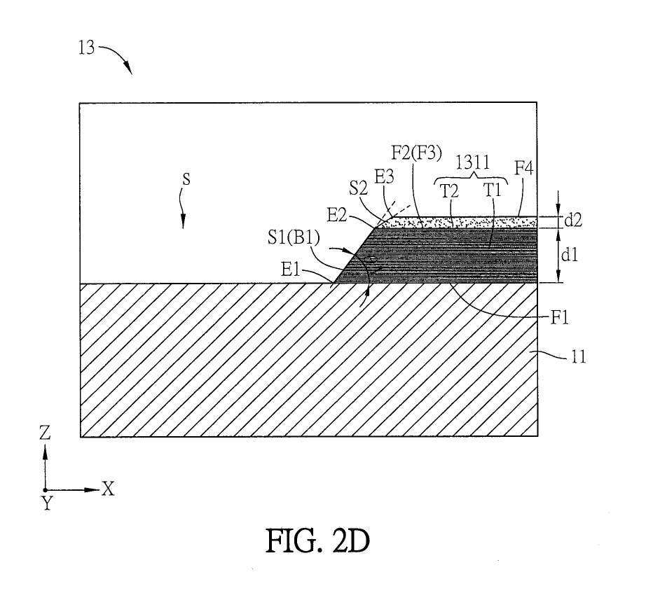

FIG. 2A is a schematic diagram showing a touch device 1 according to an embodiment of the present disclosure, FIG. 2B is a top view of a touch electrode structure 13 of the touch device 1 of FIG. 2A, FIG. 2C is an enlarged view showing an area A of the touch electrode structure 13 of FIG. 2B, and FIG. 2D is a side view showing a part of the touch electrode structure 13 of FIG. 2B. In these figures, X indicates a first direction, Y indicates a second direction, and Z indicates a third direction. Any two of the first direction X, the second direction Y and the third direction Z are substantially perpendicular to each other. For example, the first direction X is substantially parallel to the extension direction of the data lines of the touch device 1, the second direction Y is substantially parallel to the extension direction of the scan lines of the touch device 1, and the third direction Z is substantially perpendicular to the plane defined by the first direction X and the second direction Y To be noted, in some embodiments, the first direction X is not perpendicular to the second direction Y, and the included angle between the first direction X and the second direction Y is an acute angle. This disclosure is not limited.

The touch device 1 of this embodiment includes a first substrate 11, a second substrate 12, a touch electrode structure 13, a first polarizing component 14, a second polarizing component 15 and a liquid crystal layer LC.

The first substrate 11 is disposed opposite the second substrate 12. The material of the first substrate 11 and the second substrate 12 can respectively include a transparent material, such as glass, quartz or the likes, plastics, rubber, glass fiber or other polymers. Alternatively, the material of the first substrate 11 or the second substrate 12 can also include opaque materials, such as metal-glass fiber composite plate, metal-ceramic composite plate, printed circuit board or others, and it is not limited thereto. In the embodiment, the material of the first substrate 11 and the second substrate 12 includes a transparent material (e.g. glass). In addition, the touch device 1 may further include a TFT (thin film transistor) array, a color filter array and black matrix layer (not shown). The TFT array is disposed on the second substrate 12, and the color filter array or the black matrix layer is disposed on the first substrate 11 or the second substrate 12. In one embodiment, the black matrix layer and the color filter array are individually disposed on the first substrate 11. In another embodiment, the black matrix layer or the color filter array is disposed on the second substrate 1, thereby forming a BOA (BM on array) substrate or a COA (color filter on array) substrate. This disclosure is not limited.

The liquid crystal layer LC is sandwiched between the first substrate 11 and the second substrate 12. Accordingly, the first substrate 11, the second substrate 12, the liquid crystal layer LC, the TFT array and the color filter array together form a liquid crystal display panel having a plurality of subpixels (not shown). Besides, the touch device 1 may further include a plurality of scan lines and a plurality of data lines (not shown). The scan lines and the data lines are interlaced with each other so as to define the area of the pixel array.

The first polarizing component 14 is disposed on the touch electrode structure 13, and the second polarizing component 15 is disposed on one side of the second substrate 12, which is away from the first substrate 11. In practice, it is usually to use an optical adhesive (e.g. a pressure sensitive adhesive, PSA) to attach the first polarizing component 14 to the touch electrode structure 13. The first polarizing component 14 has a first absorption axis, and the second polarizing component 15 has a second absorption axis, which is perpendicular to the first absorption axis. In this case, the first polarizing component 14 and the second polarizing component 15 are polarizers, which can absorb the light with the polarization the same as the absorption axis. Since the absorption axes of the polarizing components 14 and 15 have the phase differential of substantial 90 degrees, the light from the backlight module can be blocked. Then, the intensity of the electrical field is controlled to twist the liquid crystals so as to adjust the light polarizing property for achieving the goal of image display.

The touch electrode structure 13 is disposed on the first substrate 11 and located between the first substrate 11 and the first polarizing component 14. Herein, the touch electrode structure 13 and the first substrate 11 can be combined to form a touch substrate. The material of the touch electrode structure 13 includes a composite material and has a plurality touch electrode patterns (not shown). As shown in FIG. 2B, each of the touch electrode patterns includes a trace area 131 and a driving sensing area 132. In other words, the touch electrode structure 13 includes a plurality of touch electrode patterns, which are arranged along the first direction X, and each touch electrode pattern includes a trace area 131 and a driving sensing area 132. Herein, the driving sensing area 132 contains a plurality of touch electrodes including a plurality of driving electrodes Tx and a plurality of sensing electrodes Rx. The trace area 131 contains traces for connecting the touch electrodes of the driving sensing area 132 to a control circuit board 17, which is used to process the touch signals. When the touch electrodes of the touch electrode structure 13 are touched, the touch signal can be generated and transmitted to the control circuit board 17, followed by the corresponding touch control operation.

As shown in FIG. 2C, the area A shows a trace area 131 and a driving sensing area 132. To be noted, FIG. 2C is an illustration only and is not to show the actual sizes of components in scales.

The driving sensing area 132 includes a plurality of touch electrodes containing driving electrodes Tx and sensing electrodes Rx. The trace area 131 includes a plurality of traces 1311 extending toward the same side (e.g. the bottom side of the area A or the side of the control circuit board 17). These traces 1311 are electrically connected with the driving electrode Tx and the sensing electrode Rx, and are disposed on the first substrate 11 and arranged along the first direction X.

FIG. 2D shows the trace 1311 and the adjacent slit s (see FIG. 2C), which is the area between two traces 1311 or two electrodes. As shown in FIG. 2D, the trace 1311 (or touch electrode) of the touch electrode structure 13 has a first transparent conductive layer T1 and a second transparent conductive layer T2. The first transparent conductive layer T1 is disposed on the first substrate 11, and the second transparent conductive layer T2 is stacked on the first transparent conductive layer T1. The material of the first transparent conductive layer T1 or the second transparent conductive layer T2 can include amorphous or crystalline material, and this disclosure is not limited. The refraction index of the first transparent conductive layer T1 is the same as or similar to that of the second transparent conductive layer T2. In practice, the ratio of the refraction index of the first transparent conductive layer T1 to that of the second transparent conductive layer T2 is between 0.9 and 1.1. In addition, the etching rate of the first transparent conductive layer T1 is greater than that of the second transparent conductive layer T2. Herein, the etching rate is a parameter indicating the removing rate of a substance in the etching process. The material of the first transparent conductive layer T1 includes, for example but not limited to, IZO (indium-zinc oxide) or ITO (indium-tin oxide), and the material of the second transparent conductive layer includes, for example but not limited to, ITO (indium-tin oxide) or Ge:ITO (germanium:indium-tin oxide). As mentioned above, the refraction indexes of IZO and ITO are similar (n−2), but the etching rate of IZO is about 37 Å/second and the etching rate of ITO is about 10 Å/second.

In this embodiment, the first transparent conductive layer T1 has a first thickness d1, and the second transparent conductive layer T2 has a second thickness d2. Herein, the first thickness dl of the first transparent conductive layer T1 is 1200 Å, and the second thickness d2 of the second transparent conductive layer T2 is 200 Å. Accordingly, the sum of the first thickness dl and the second thickness d2 is about 1400 Å. In addition, the ratio of the first thickness d1 to the second thickness d2 is between 0.1 and 10 (0.1≦d1/d2≦10). In this case, the ratio of the first thickness d1 to the second thickness d2 is 6.

Furthermore, the first transparent conductive layer T1 has a first side surface S1 located at a first side B1 of the first transparent conductive layer T 1, and the second transparent conductive layer T2 has a second side surface S2 located above the first side B1. That is, the second side surface S2 is positioned above the first side surface S1. In this embodiment, an included angle θ1 between the first substrate 11 and the first side surface S1 of the first transparent conductive layer T1 is 54.46°. In addition, the first side surface S1 has a first slope, and the second side surface S2 has a second slope. The absolute value of the first slope is greater than that of the second slope. Herein, the first slope is the tangent slope of the first side surface S1, while the second slope is the tangent slope of the second side surface S2.

In more specific, when a line lifts from left to right, the slope of the line is positive; otherwise, when a line descends from left to right, the slope of the line is negative. The first slope of the first side surface S1 and the second slope of the second side surface S2 are both positive. However, in some embodiments, the first and second slopes can be both negative; in some embodiments, one of the first and second slopes is positive and the other one is negative. The critical point is that the absolute value of the first slope of the first side surface S1 of the first transparent conductive layer T1 is greater than that of the second slope of the second side surface S2 of the second transparent conductive layer T2. In this embodiment, the first transparent conductive layer T1 has a first surface F1 and a second surface F2, which are disposed opposite to each other and both connect to the first side surface S1. At the first side B1, the first surface F1 and the first side surface S1 are connected at a first end E1, and the second surface F2 and the first side surface S1 are connected at a second end E2. The first slope is the slope of the line connecting the first end E1 and the second end E2. Besides, the second transparent conductive layer T2 has a third surface F3 and a fourth surface F4, which are disposed opposite to each other and both connect to the second side surface S2. Similarly, the third surface F3 and the second side surface S2 are connected at the second end E2, and the fourth surface F4 and the second side surface S2 are connected at a third end E3. The second slope is the slope of the line connecting the second end E2 and the third end E3.

In this embodiment, the etching rate of the first transparent conductive layer T1 is higher than that of the second transparent conductive layer T2. Accordingly, after the etching process of the first transparent conductive layer T1 and the second transparent conductive layer T2, the absolute value of the first slope of the first side surface S1 of the first transparent conductive layer T1 is greater than that of the second slope of the second side surface S2 of the second transparent conductive layer T2. As a result, the length of the slant surface of the trace 1311 (or touch electrode) of the touch electrode structure 13 is shorter than the conventional art, thereby decreasing the amount of the reflected light and thus improving the visibility of the touch substrate and touch device 1.

To be noted, the manufacturing process of the touch electrode structure 13 includes the following steps of: forming a first transparent conductive layer T1 on a substrate 11; forming a second transparent conductive layer T2 stacked on the first transparent conductive layer T1; performing a series of lithography processes including applying a photoresist layer, exposing and developing processes; post baking; etching; and removing the photoresist. Afterwards, the desired touch electrode structure 13 is formed on the substrate 11. Of course, in other embodiments, the post baking process can be removed. That is because the post baking process may harden the second transparent conductive layer T2, and the hardened second transparent conductive layer T2 will have a much lower etching rate in the following etching process (e.g. by oxalic acid), which may cause the undesired obtuse angle.

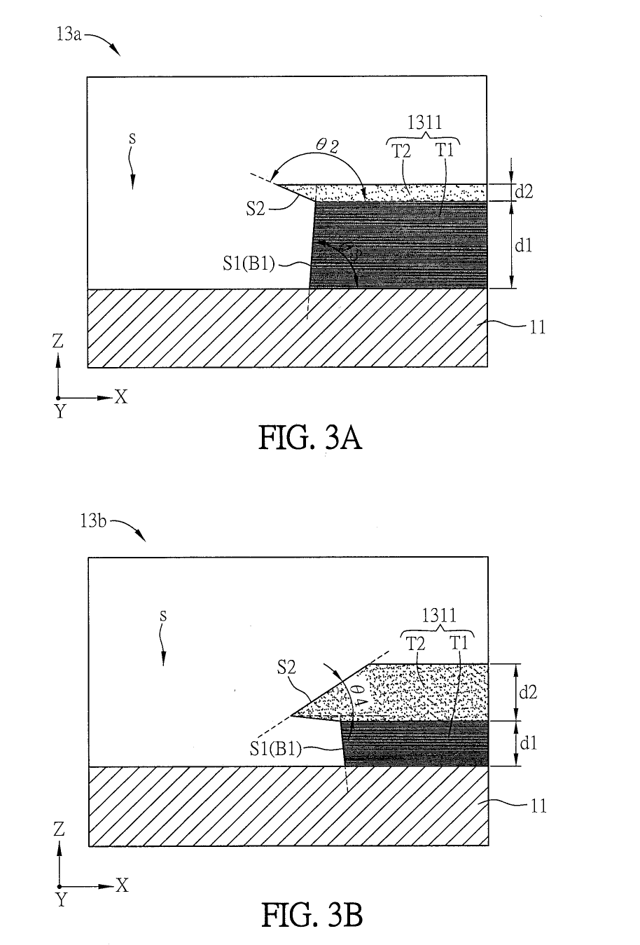

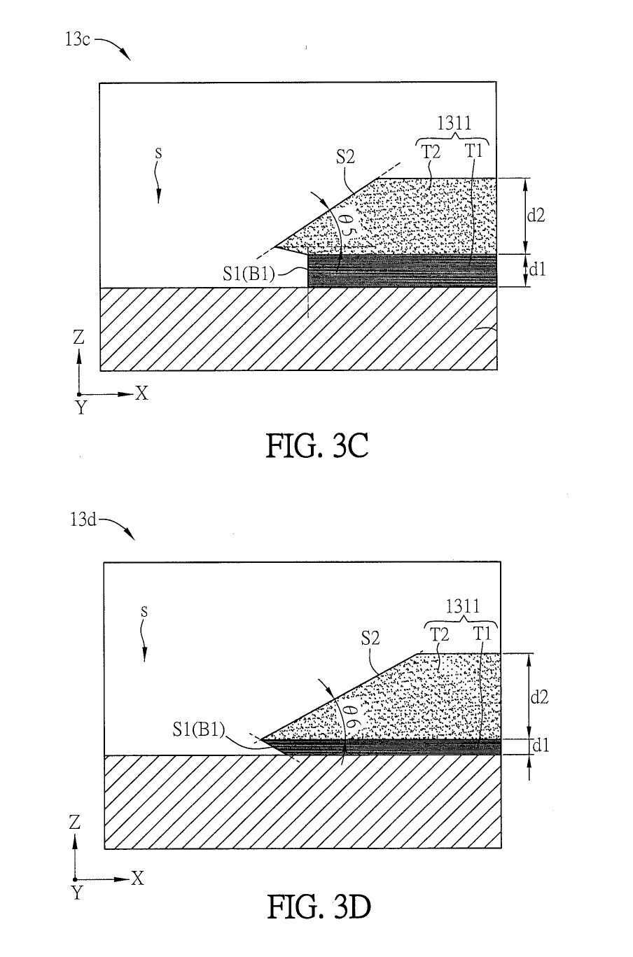

FIG. 3A to FIG. 3D are partial side views of the touch electrode structures 13a-13d of different aspects. Similar to the touch electrode structure 13, each of the touch electrode structures 13a-13d includes a first transparent conductive layer T1 disposed on the first substrate 11 and a second transparent conductive layer T2 stacked on the first transparent conductive layer T1. In each of the touch electrode structures 13a-13d, the slope of the first side surface S1 of the first transparent conductive layer T1 is greater than that of the slope of the second side surface S2 of the second transparent conductive layer T2.

Different from the aspect of FIG. 2D, the first thickness dl of the first transparent conductive layer T1 of the touch electrode structure 13a of FIG. 3A is 1160 Å, and the second thickness d2 of the second transparent conductive layer T2 is 232 Å (d1+d2=1392 Å). The included angle θ2 formed between the second side surface S2 and the bottom surface of the second transparent conductive layer T2 is an obtuse angle, such as an angle of 155.22°. Besides, the included angle θ3 between the first substrate 11 and the first side surface S1 of the first transparent conductive layer T1 is 85.68°.

Different from the aspect of FIG. 2D, the first thickness d1 of the first transparent conductive layer T1 of the touch electrode structure 13b of FIG. 3B is 696 Å, and the second thickness d2 of the second transparent conductive layer T2 is 696 Å, too (d1+d2=1392 Å). The included angle θ4 between the second side surface S2 of the second transparent conductive layer T2 and an axis parallel to the first direction X is 32.62°. Besides, the included angle between the first substrate 11 and the first side surface S1 of the first transparent conductive layer T1 is roughly greater than 90°.

Different from the aspect of FIG. 20, the first thickness d1 of the first transparent conductive layer T1 of the touch electrode structure 13c of FIG. 3C is 464 Å, and the second thickness d2 of the second transparent conductive layer T2 is 968 Å (d1+d2=1432 Å). The included angle θ5 between the second side surface S2 of the second transparent conductive layer T2 and an axis parallel to the first direction X is 34.26°. Besides, the included angle between the first substrate 11 and the first side surface S1 of the first transparent conductive layer T1 is about 90°.

Different from the aspect of FIG. 2D, the first thickness dl of the first transparent conductive layer T1 of the touch electrode structure 13d of FIG. 3D is 232 Å, and the second thickness d2 of the second transparent conductive layer T2 is 1160 Å (d1+d2=1392 Å). The included angle θ6 between the second side surface S2 of the second transparent conductive layer T2 and an axis parallel to the first direction X is 29.27°. Besides, the included angle between the first substrate 11 and the first side surface S1 of the first transparent conductive layer T1 is greater than 90°. In addition, the included angle between the first side surface S1 and the bottom surface of the first transparent conductive layer T1 is an obtuse angle.

To be noted, the other features of the touch electrode structures 13a-13d can be referred to those of the touch electrode structure 13, so the detailed description thereof will be omitted.

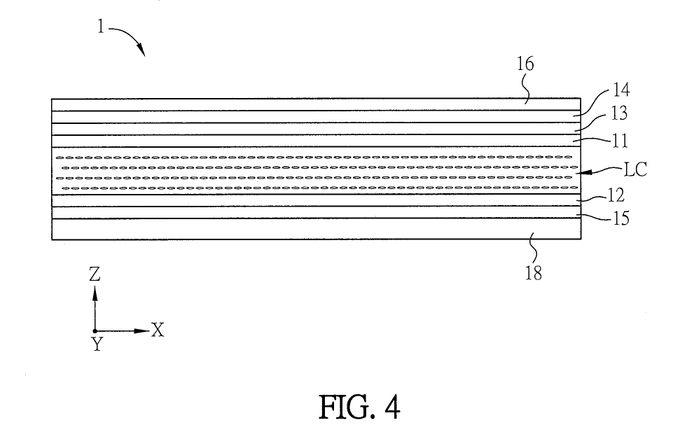

FIG. 4 is a schematic diagram showing another touch device 1 of the present disclosure. As shown in FIG. 4, the touch device 1 further includes a protective substrate 16, which is for example but not limited to a cover lens. The configuration of the protective substrate 16 can protect the components from impact or invasion of dusts or water vapors. In addition, the touch device 1 of this embodiment may further include a backlight module 18, which is disposed opposite the second substrate 12 for emitting light to the second substrate 12. Accordingly, the liquid crystal display panel can display images based on the light from the backlight module 18. In general, the backlight module 18 includes a light-emitting element, a light guider, a reflective plate, a plurality of optical films and the likes. The functions and configurations of the components of the backlight module 18 are well known by those skilled persons, so the detailed descriptions thereof will be omitted.

As mentioned above, the touch electrode structure 13 of this embodiment is applied to the LCD panel. However, in different embodiments, the touch electrode structure 13 can also be applied to the OLED (organic light emitting diode) display. In this case, the touch device is also an OLED display panel.

In summary, the touch electrode structure of the touch substrate and touch device of the disclosure has a second transparent conductive layer stacked on a first transparent conductive layer, and the absolute value of a slope of the first side surface of the first transparent conductive layer is greater than that of the second side surface of the second transparent conductive layer. Accordingly, the length of the traces of the touch electrode structure or the slant surface of the touch electrode is shorter than the conventional design, thereby decreasing the light reflection amount of the touch sensing structure so as to improve the visibility of the touch substrate and touch device.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A touch substrate, comprising:
a substrate; and
a touch electrode structure having a first transparent conductive layer and a second transparent conductive layer, the first transparent conductive layer disposed on the substrate and the second transparent conductive layer disposed on the first transparent conductive layer;
wherein, the first transparent conductive layer has a first side surface located at a first side of the first transparent conductive layer, the second transparent conductive layer has a second side surface located above the first side, the first side surface has a first slope, the second side surface has a second slope, and the absolute value of the first slope is greater than that of the second slope.

2. The touch substrate of claim 1, wherein the material of each of the first and second transparent conductive layers comprises amorphous or crystalline material.

3. The touch substrate of claim 1, wherein the material of the first transparent conductive layer comprises IZO (indium-zinc oxide) or ITO (indium-tin oxide), and the material of the second transparent conductive layer comprises ITO (indium-tin oxide) or Ge:ITO (germanium:indium-tin oxide).

4. The touch substrate of claim 1, wherein an etching rate of the first transparent conductive layer is greater than that of the second transparent conductive layer.

5. The touch substrate of claim 1, wherein the first transparent conductive layer has a first thickness, the second transparent conductive layer has a second thickness, and the ratio of the first thickness to the second thickness is between 0.1 and 10.

6. The touch substrate of claim 1, wherein the touch electrode structure has a plurality touch electrode patterns, which are arranged along a direction, and each of the touch electrode patterns comprises a trace area and a driving sensing area.

7. The touch substrate of claim 6, wherein the trace area comprises a trace, the driving sensing area contains a touch electrode, and the trace connects to the touch electrode and a control circuit board.

8. The touch substrate of claim 6, wherein the trace area comprises a trace, the driving sensing area contains a touch electrode, and the trace or the touch electrode has the first transparent conductive layer and the second transparent conductive layer.

9. The touch substrate of claim 1, wherein a ratio of a refraction index of the first transparent conductive layer to that of the second transparent conductive layer is between 0.9 and 1.1.

10. The touch substrate of claim 1, wherein the first side surface and a bottom surface of the first transparent conductive layer or the second side surface and a bottom surface of the second transparent conductive layer are formed with an obtuse angle.

11. A touch device, comprising:
a first substrate;
a second substrate disposed opposite to the first substrate; and
a touch electrode structure having a first transparent conductive layer and a second transparent conductive layer, the first transparent conductive layer disposed on the first substrate and the second transparent conductive layer disposed on the first transparent conductive layer;
wherein, the first transparent conductive layer has a first side surface located at a first side of the first transparent conductive layer, the second transparent conductive layer has a second side surface located above the first side, the first side surface has a first slope, the second side surface has a second slope, and the absolute value of the first slope is greater than that of the second slope.

12. The touch device of claim 11, wherein the material of each of the first and second transparent conductive layers comprises amorphous or crystalline material.

13. The touch device of claim 11, wherein the material of the first transparent conductive layer comprises IZO (indium-zinc oxide) or ITO (indium-tin oxide), and the second transparent conductive layer is made of ITO (indium-tin oxide) or Ge :ITO (germanium:indium-tin oxide).

14. The touch device of claim 11, wherein an etching rate of the first transparent conductive layer is greater than that of the second transparent conductive layer.

15. The touch device of claim 11, wherein the first transparent conductive layer has a first thickness, the second transparent conductive layer has a second thickness, and the ratio of the first thickness to the second thickness is between 0.1 and 10.

16. The touch device of claim 11, wherein the touch electrode structure has a plurality touch electrode patterns, which are arranged along a direction, and each of the touch electrode patterns comprises a trace area and a driving sensing area.

17. The touch device of claim 16, further comprising:
a control circuit, wherein the trace area comprises a trace, the driving sensing area contains a touch electrode, and the trace connects to the touch electrode and a control circuit board.

18. The touch device of claim 16, wherein the trace area comprises a trace, the driving sensing area contains a touch electrode, and the trace or the touch electrode has the first transparent conductive layer and the second transparent conductive layer.

19. The touch device of claim 11, wherein a ratio of a refraction index of the first transparent conductive layer to that of the second transparent conductive layer is between 0.9 and 1.1.

20. The touch device of claim 11, wherein the first side surface and a bottom surface of the first transparent conductive layer or the second side surface and a bottom surface of the second transparent conductive layer are formed with an obtuse angle.
